(19) United States
(12) Patent Application Publication
(10) Pub. No.: US 2007/0095815 A1
(43) Pub. Date: May 3, 2007

(54) Electric heating device for a motor vehicle

(75) Inventors: Michel Brun, Rustenhard (FR); Jean-Luc Delamarche, Burnhaupt (FR); Matthieu Mougey, Ensisheim (FR)

Correspondence Address: FOLEY AND LARDNER LLP;SUITE 500, 3000 K STREET NW, WASHINGTON, DC, 20007, US

(73) Assignee: BEHR FRANCE S.A.R.L.

(21) Appl. No.: 10/582,523

(22) PCT Filed: Nov. 23, 2004
(86) PCT No.: PCT/EP04/13269

§ 371 Date: Aug. 16, 2006

(30) Foreign Application Priority Data
Dec. 12, 2003 (EP) 03293165.1

(51) Int. Cl. H05B 3/02

(52) U.S. Cl. 219/481; 219/507

(57) ABSTRACT

The invention relates to an electric heating device (1) comprising at least one heating element and a control device (4). An emergency cutout is provided in the event of a crash such that an electric short circuit can be effectively prevented in the electric heating device (1) or a fire following undesired overheating can be effectively prevented in the event of said crash.

The invention relates to an electric heating device for a motor vehicle, according to the preamble of claim 1.

DE 199 11 547 A1 discloses an electric heating device for a motor vehicle, having a heating block which is formed from a plurality of heating elements, which are arranged in parallel and have PTC elements, and corrugated ribs, which rest on the heating elements so as to form a thermal connection, and which is braced in a frame by means of at least one spring element.

A further electric heating device for a motor vehicle is known from DE 199 57 452 A1. This electric heating device has a plurality of heating elements, which are combined to form a heating block which is held in a frame and through which a medium which is to be heated can flow, and a control apparatus having a plurality of control components which are to be cooled, are arranged in a row next to or within the heating block, and serve to actuate the heating elements. In this case, the control components to be cooled have an associated, common, thermally connected corrugated cooling rib which extends along the row of control components and/or said control components are electrically connected by a heating current-conducting connection to a connection conductor strip which is connected to a contact strip which extends perpendicular to the latter along a side region of the block and to which the heating elements are jointly connected.

However, heating devices of this type leave something to be desired, in particular with regard to their safety in the event of a crash.

The object of the invention is to provide an improved heating device.

This object is achieved by means of an electric heating device having the features of claim 1. The subclaims relate to advantageous refinements.

The invention provides an electric heating device having at least one electric heating element and a control apparatus, with an emergency switch-off means being provided for the event of a crash, so that an electrical short circuit in the electric heating device or a fire resulting from undesired and excessive heating in the event of a crash can be reliably avoided.

The emergency switch-off means is preferably formed by a switch which is triggered automatically in the event of a crash. The emergency switch-off means can be electronically reset by hand or by means of the control apparatus, with the result that it can be used several times, however it is also possible, in principle, to use an embodiment of the emergency switch-off means which cannot be reset, with the result that replacement is ensured and the new emergency switch-off means can operate without restriction in the event of a further crash.

The electric heating device preferably has at least one PTC element, but with preference a plurality of PTC elements which form the individual heating elements.

The switch of the emergency switch-off means may be arranged either in the region of the heating element or else in the region of the control apparatus, at a distance from the heating element.

The emergency switch-off means preferably comprises an integrated sensor which automatically triggers the switch of the emergency switch-off means in the event of a crash, it being possible for the sensor to be integrated directly in the switch, for example on account of acceleration which occurs in the event of a crash. In this case, the sensor has at least one moving element which is moved in relation to the rest of the switch by the acceleration which occurs in the event of a crash.

A central sensor can equally be provided for the emergency switch-off means, this sensor also being connected to other control devices for safety components of the motor vehicle, which control devices activate the safety components in the event of a crash.

The invention is explained in detail below using two exemplary embodiments with reference to the drawing, in which

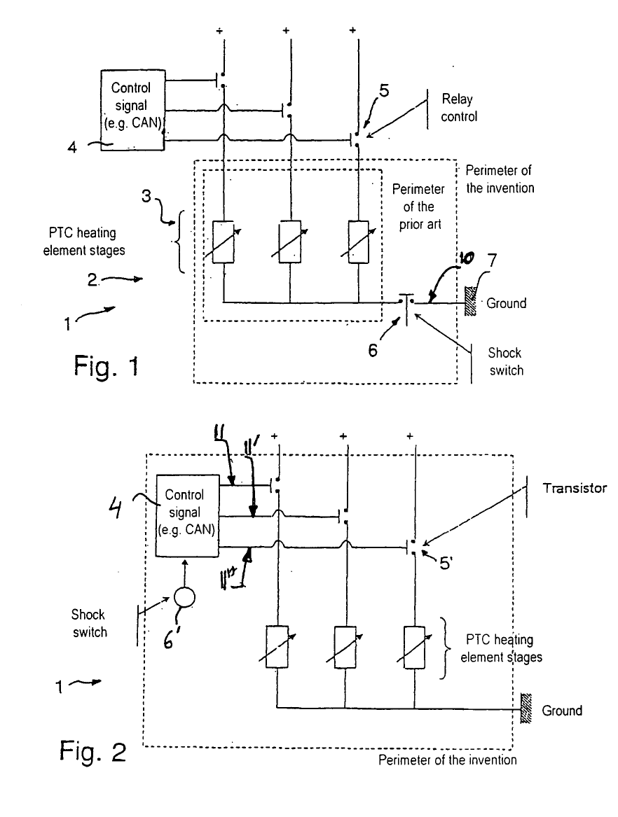

FIG. 1 shows a schematic circuit of a PTC auxiliary heater according to the first exemplary embodiment, and

FIG. 2 shows a schematic circuit of a PTC auxiliary heater according to the second embodiment.

An electric heating device 1 of a motor vehicle air-conditioning system, which is used as an auxiliary heater, has an electric circuit 2, which has a plurality of PTC elements 3 which are used to convert electrical energy into heat, and a control device 4 which, in the present exemplary embodiment, only recognizes the states “ON” and “OFF”, it being possible to actuate the PTC elements 3 individually by means of corresponding relays 5. The control signals can be transmitted from the control device 4 to the relays 5 by means of a vehicle bus, such as the CAN bus or LIN bus, for example.

In order to ensure that the electric heating system is switched off in the event of a crash, a switch 6 provides an emergency switch-off means. This switch 6 interrupts the electric circuit 2, and thus the power signal 10, between the PTC elements 3 and ground 7 which is common to all of the PTC elements 3 (see FIG. 1). In this case, the switch 6 is independent of the control device 4, so that the emergency switch-off means forms a second control device in the electric circuit 2. According to the first exemplary embodiment, the switch 6 has components which are moved by the acceleration which occurs in the event of a crash, and this interrupts the electric circuit. In this case, the switch is formed in such a way that it can be operated only once and then has to be replaced. However, it is also possible to use a switch which can be operated several times and reset by hand, for example.

According to the second exemplary embodiment which is illustrated in FIG. 2, the emergency switch-off means is integrated in the control device 4. The PTC elements 3 are PTC elements which comprise a controller, so that transistors 5′ which are controlled by the control device 4 via control signals 11, 11′, 11″ are provided in place of the relays 5 for the individual PTC elements 3. In the present case, the switch 6′ for the emergency switch-off means is integrated directly in the printed circuit board of the controller, so that the emergency switch-off means according to the second exemplary embodiment can be produced at a lower cost than that of the first exemplary embodiment, but the further design of the electric heating device 1 according to the first exemplary embodiment is considerably more simple and cost-effective. In contrast to the switch 6 from FIG. 1, the switch 6′ does not interrupt the power signal 10 directly but interrupts or blocks the control signals 11, 11′ and 11″, so that the transistors 5′ assume an off state and no more current flows through the PTC elements 3.

In the event of a crash, the emergency switch-off means ensures that the electric heating device is switched off. The risk of a short circuit in the electric circuit and thus the risk of a fire are therefore reduced. The number of PTC elements which can be controlled by a single emergency switch-off means is unlimited in principle.

### LIST OF REFERENCE SYMBOLS

1 Electric heating device
2 Electric circuit
3 PTC element
4 Control device
5 Relay
5′ Transistor
6, 6′ Switches
7 Ground
10 Power signal
11, 11′, 11″ Control signals

1. An electric heating device having at least one electric heating element and a control apparatus wherein an emergency switch-off means is provided for the event of a crash.

2. The electric heating device as claimed in claim 1, wherein the emergency switch-off means is a switch which is triggered automatically in the event of a crash.

3. The electric heating device as claimed in claim 1, wherein the emergency switch-off means can be electronically reset by hand or by means of the control apparatus.

4. The electric heating device as claimed in claim 1, wherein the electric heating device has at least one PTC element

5. The electric heating device as claimed in claim 1, wherein the switch switches a power signal.

6. The electric heating device as claimed in claim 5, wherein the switch of the emergency switch-off means is arranged in the region of the heating element.

7. The electric heating device as claimed in claim 1, wherein the switch switches at least one control signal.

8. The electric heating device as claimed in claim 7, wherein the switch of the emergency switch-off means is arranged in the region of the control apparatus at a distance from the heating element.

9. The electric heating device as claimed in claim 1, wherein the emergency switch-off means comprises an integrated sensor which automatically triggers the emergency switch-off means in the event of a crash.

10. The electric heating device as claimed in claim 1, wherein the emergency switch-off means can be triggered by a central sensor.

11. A motor vehicle air-conditioning system characterized by an electric heating device as claimed in claim 1.
